(19) United States
(12) Patent Application Publication
(10) Pub. No.: US 2026/0356192 A1
(43) Pub. Date: Nov. 12, 2026

(54) LAND VEHICLE WITH PIVOTAL TANDEM WHEEL PAIRS RESPECTIVELY WITH SINGLE ELECTRIC DRIVE MOTOR

(71) Applicant: BEONYX ROBOTICS INC., Chicoutimi (CA)

(72) Inventor: Michael Martel, Chicoutimi (CA)

(21) Appl. No.: 19/129,493

(22) PCT Filed: Oct. 11, 2023
(86) PCT No.: PCT/CA2023/051343

§ 371 Date: May 13, 2025

(51) Int. Cl. B60K 17/36; B60K 7/00; B60K 17/342; B60K 17/356

(52) U.S. Cl. CPC B60K 17/36; B60K 17/342; B60K 17/356; B60K 7/0007; B60K 2007/0046

(57) ABSTRACT

A land vehicle comprises a frame supported for movement across a support surface having longitudinally opposite front and rear ends and laterally opposite sides. The vehicle includes plural pivotal tandem wheel pairs respectively formed by a distinct pair of longitudinally adjacent wheels supported for pivotal movement about a common pivot axis for the wheels of the tandem pair. The vehicle further includes electric drive motors supported at the sides of the frame and respectively associated with the tandem pairs. Each motor supports one of the wheels of each tandem pair, such that a rotational axis of the master drive wheel is the same as an axis of a drive shaft of the motor. The other wheel of each tandem pair is operatively connected to the motor associated with that tandem pair by a transmission to form a slave drive wheel driven in rotation about its own rotational axis.

### FIELD OF THE INVENTION

The present invention relates generally to a land vehicle with plural tandem wheel pairs that are pivotally supported for pivoting or swivelling movement each about a substantially laterally-oriented pivot axis, which is transversely oriented relative to a direction of travel of the vehicle, and driven by hub-mounted electric motors, and more particularly to such a land vehicle in which each tandem wheel pair is driven by only one electric motor.

### BACKGROUND

According to one common arrangement of electrically driven all-terrain land vehicles with hub-mounted electric motors, each of the drive wheels receives one of the hub-mounted motors so as to be driven thereby. Therefore, if all traction wheels, that is wheels which are in rolling engagement with the ground or an underlying support surface, whether directly or indirectly such as by a track, are to be drive wheels, then providing a hub-mounted electric motor for each of the wheels acts to increase cost of the machine and weight of the machine, which in turn tends to reduce (travel or operating) range when the vehicle is battery-powered.

### SUMMARY OF THE INVENTION

According to an aspect of the invention there is provided a land vehicle comprising:
a frame arranged for movement across a support surface, wherein the frame has longitudinally opposite front and rear ends and laterally opposite sides;
a plurality of wheels supported at the sides of the frame for supporting the frame in movement across the support surface, wherein the wheels on common sides of the frame are arranged in tandem pairs including respective ones of the wheels which are adjacent each other relative to a longitudinal direction of the frame;
wherein each of the tandem pairs of the wheels is supported for pivotal movement relative to the frame about a substantially laterally oriented pivot axis, wherein the pivot axis is disposed longitudinally intermediate respective rotational axes of the wheels of the tandem pair;
wherein the respective rotational axis of each wheel of each tandem pair is distinct from the pivot axis associated with the tandem pair to which the wheel belongs;
an electric power source carried on the frame and configured to supply electrical power;
a plurality of electric drive motors operatively connected to the electric power source so as to be configured to receive the electrical power therefrom, wherein the electric drive motors are supported at the sides of the frame and respectively associated with the tandem pairs of the wheels, wherein each of the electric drive motors has a drive shaft configured to rotate about an axis thereof responsive to electrical power to the electric drive motor;
wherein a first one of the wheels of each tandem pair is rotationally supported on the drive shaft of an associated one of the electric drive motors to form a master drive wheel of the tandem pair, wherein the respective rotational axis of the master drive wheel is defined by the drive shaft of the associated electric motor; and
wherein a second one of the wheels of each tandem pair is operatively connected to the associated electric drive motor by a transmission to form a slave drive wheel driven in rotation about the respective rotational axis thereof.

This provides an all-wheel-drive configuration of the land vehicle utilizing ‘hub-mounted’ electric motors, as they are typically referred to in industry, but in a quantity fewer than the number of wheels, which may improve electrical efficiency of the vehicle, reduce cost of production of such a vehicle and reduce weight or mass of such a vehicle which in turn may improve battery travel range.

Preferably, the land vehicle further includes a plurality of brakes respectively operatively connected to the slave drive wheels of the tandem pairs of the wheels so as to be configured for braking the slave drive wheels. This acts to complement, within each tandem pair, braking by the electric motor on the master drive wheel.

Preferably, the brakes are electromagnetic brakes operatively connected to the electric power source so as to be configured to receive electrical power therefrom. Typically, the electromagnetic brakes are configured to be biased to a braking or stopping position when there is no electrical power applied thereto, so as to resist rotation of the wheel to which the respective brake is operatively connected.

When the slave drive wheel of each tandem pair includes a shaft rotatably supported at a corresponding one of the sides of the frame, the transmission operatively interconnecting the slave drive wheel with the associated electric drive motor is preferably in the form of a rotary loop member operatively supported on the drive shaft of the electric drive motor and the shaft of the slave drive wheel.

In the illustrated arrangement, the rotary loop member is entrained on support wheels respectively mounted in fixed rotational relation to the drive shaft of the electric drive motor and the shaft of the slave drive wheel. Thus, the shaft of the slave drive wheel rotates at the same speed as the drive shaft of the electric drive motor.

When the master drive wheel is supported on the drive shaft of the electric drive motor on an outer side thereof distal to the frame, a respective one of the support wheels mounted to the drive shaft is preferably supported thereon in opposite axial relation to the master drive wheel such that the drive shaft protrudes from an inner side of the electric drive motor proximal to the frame.

When a hub of the slave drive wheel is supported at or adjacent an outer end of the shaft of the slave drive wheel distal to the frame and when the shaft extends from the outer end to an inner end proximal to the frame, a respective one of the support wheels supported on the shaft of the slave drive wheel is preferably disposed at or adjacent the inner end of the shaft of the slave drive wheel.

Preferably, the wheels of each tandem pair are supported on a support member in the form of a housing which is substantially enclosed and the rotary loop member is inside the housing. Preferably, the rotary loop member is a belt and the support wheels are pulleys.

Preferably, for each tandem pair of the wheels, the pivot axis is colinear with the rotational axes of the wheels of the tandem pair and upper and lower runs of the rotary loop member are guided to a common side of the pivot axis.

Furthermore, in the illustrated arrangement, the pivot axis is centrally intermediate the rotational axes of the wheels of the tandem pair so as to be equidistant to each of the rotational axes.

When the electric drive motor of each tandem pair has a stator and a rotor, the electric drive motor preferably further includes an internal transmission operatively connecting the rotor and the drive shaft and configured to provide a reduced rotational speed of the drive shaft relative to the rotor. This in turn acts to increase rotational torque applied to the drive shaft and accordingly the torque of the vehicle.

In the illustrated arrangement, the internal transmission is in the form of a planetary gearset.

When the rotor is supported for rotation around the stator outwardly thereof relative to a radial direction of the electric drive motor, the internal transmission is preferably disposed axially intermediate the rotor and the stator.

When the tandem pairs of the wheels are provided in laterally opposite pairs which are registered with each other at a common longitudinal position of the frame, the master drive wheels of the tandem pairs of a common one of the laterally opposite pairs are rear ones of the wheels of the tandem pairs. Typically, in such an arrangement, the tandem pairs of the common laterally opposite pair share a common pivot axis.

### BRIEF DESCRIPTION OF THE DRAWINGS

The invention will now be described in conjunction with the accompanying drawings in which:

FIG. 1 is a perspective view of an arrangement of land vehicle according to the present invention;

FIG. 2 is a side elevational view of the arrangement of land vehicle of FIG. 1;

FIG. 3 is a bottom plan view of the arrangement of land vehicle of FIG. 1;

FIG. 4 is a cross-sectional view along line 4-4 in FIG. 2;

FIG. 5 is a cross-sectional view along line 5-5 in FIG. 3;

FIG. 6 is a top plan view of the arrangement of land vehicle of FIG. 1;

FIG. 7 is a close-up partial view of the area indicated at I in FIG. 4;

FIG. 8 is an elevational view of a tandem wheel pair of the arrangement of land vehicle of FIG. 1 as if it were taken along line 8-8 in FIG. 7 and with some components omitted for clarity of illustration; and

FIG. 9 is a cross-sectional view taken along line 9-9 in FIG. 7.

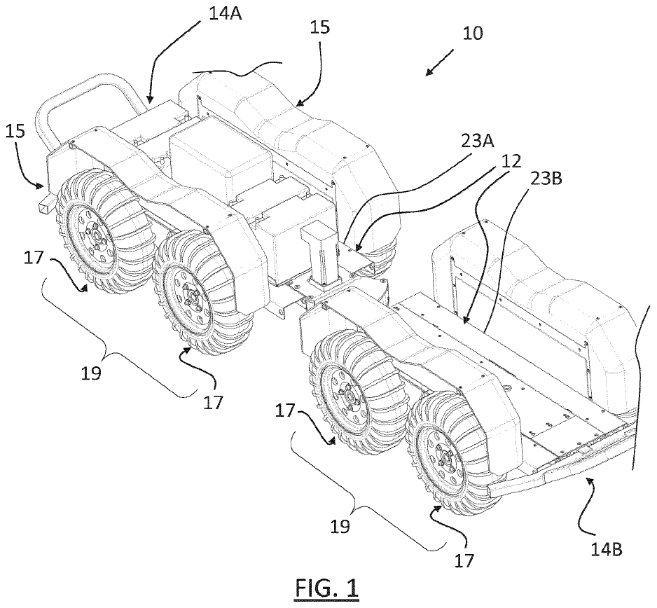

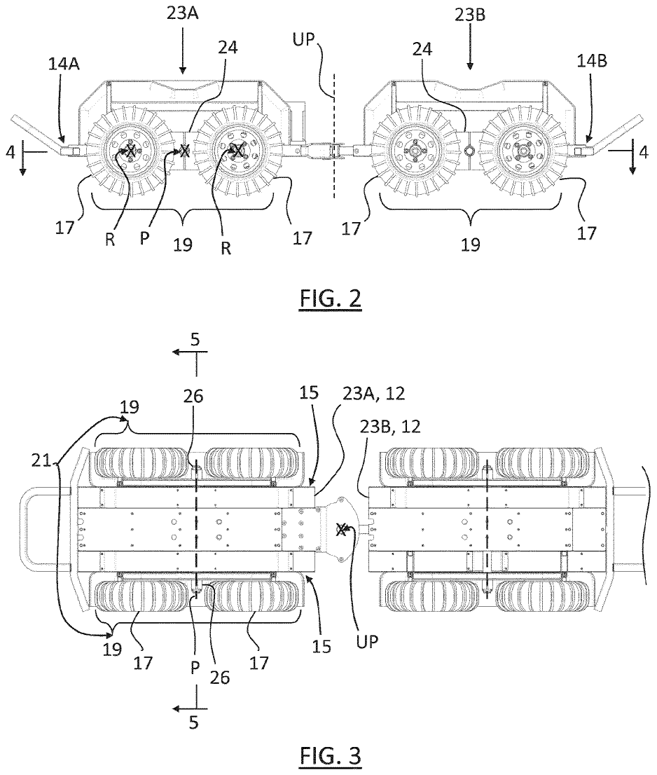

In the drawings like characters of reference indicate corresponding parts in the different figures.

### DETAILED DESCRIPTION

The accompanying figures show a land vehicle, which is generally indicated at 10, for traversing surfaces on land and, in particular, non-paved or offroad terrain.

The land vehicle 10 generally comprises a frame 12 arranged for movement across a support surface, such as a ground surface formed by a ground material, and having longitudinally opposite front and rear ends 14A, 14B and laterally opposite sides 15. Also, the vehicle 10 comprises a plurality of wheels 17 supported at the sides 15 of the frame for supporting the frame 12 in movement across the support surface. Typically, the wheels 17 are surface-engaging wheels arranged in rolling engagement with the support surface across which the vehicle is to travel. In some arrangements, the wheels may support a closed loop member entrained on the wheels and forming a track to improve traction of the vehicle.

The wheels 17 on common sides 15 of the frame 12 are arranged in tandem pairs 19 including respective ones of the wheels which are adjacent each other relative to a longitudinal direction of the frame. In other words, the vehicle 10 has a plurality of pairs of wheels, indicated at 19, which are distinct pairs of longitudinally adjacent wheels. Each wheel belongs only to one tandem pair, and each tandem pair 19 is distinct. Furthermore, the tandem pairs 19 are grouped in laterally opposite pairs, that is two tandem pairs which are disposed on laterally opposite sides 15 of the vehicle and at a common longitudinal location relative to the frame. As such, the vehicle 10 has at least at least one laterally opposite pair of tandem wheel pairs, indicated at 21, which cooperate for supporting in movement the frame across the support surface, and consequently, the total number of wheels is a multiple of four. In the illustrated arrangement, there are a total of eight wheels, indicated at 17, forming four tandem pairs, indicated at 19, and two laterally-opposite, and hence cooperative, pairs 21 of the tandem wheel pairs 19. Furthermore, in the illustrated arrangement, it will be appreciated that the frame 12 has distinct front and rear frame portions 23A, 23B interconnected for relative movement about an upstanding pivot axis UP and each support one cooperative pair 21 of tandem wheel pairs. The front frame portion 23A defines the front end 14A of the vehicle, and the rear frame portion 23B defines the rear end 14B of the vehicle.

Each tandem pair 19 of the wheels 17 is supported for pivotal movement relative to the frame 12 about a substantially laterally oriented pivot axis P. That is, each pair 19 of longitudinally adjacent wheels, as a grouping, are pivotally movable about the pivot axis P such that the individual wheels 17 remain in fixed relation relative to each other in movement about the pivot axis P. This is achieved by supporting the wheels of each tandem pair 19 on a generally longitudinally extending support member 24, which is pivotally connected to, so as to be pivotally supported by, a substantially laterally oriented shaft 26 defining the pivot axis P. The pivot shaft 26 is supported by the frame 12 and is disposed longitudinally intermediate respective rotational axes R of the wheels 17 of the tandem pair 19 to locate the pivot axis in the same manner, such that the individual wheels of the pair are movable about the axis P in opposite directions relative to the support surface, so as to assist in articulating uneven terrain. Typically, as in the illustrated arrangement, each laterally-opposite, longitudinally-registered pair 21 of the tandem wheel pairs 19 are pivotally supported by a common shaft 26 so as to share a common pivot axis P. Especially, in such an arrangement with the common pivot axis for the laterally opposite pair of tandem pairs, the pivot axis is perpendicularly transverse to the longitudinal direction so as to be laterally oriented. Furthermore, in the illustrated arrangement, each one of the laterally opposite pair of tandem pairs is independently pivotable of the other one of the laterally opposite pair of tandem pairs relative to the common shaft on which the tandem pairs are pivotally supported.

Furthermore, the respective rotational axis R of each wheel 19 of each tandem pair 21 is distinct from the pivot axis P associated with the tandem pair to which the wheel belongs. Accordingly, the rotational axes R of the individual wheels 19 of each tandem pair 21 are longitudinally spaced from the pivot axis P associated with the tandem pair. In the illustrated arrangement, the rotational axes R of laterally opposite ones of the wheels 17 are registered with each other such that the laterally opposite pair of wheels share a common rotational axis, although not necessarily a common shaft defining the respective rotational wheel axis.

For self-propulsion, the vehicle 10 includes an electric power source 29 carried on the frame 12 and configured to supply electrical power. Typically, the power source 29 is in the form of a rechargeable battery configured to supply DC electrical power. Alternatively, the power source may be an electric generator configured to be driven by an internal combustion engine, and the engine is adapted to combust a fossil fuel such as liquid propane gas.

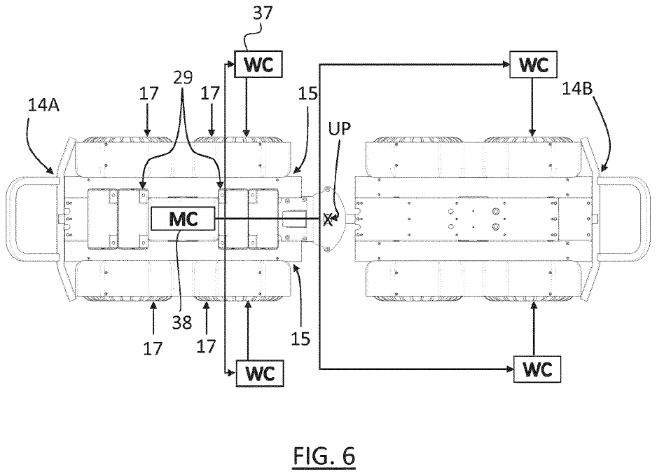

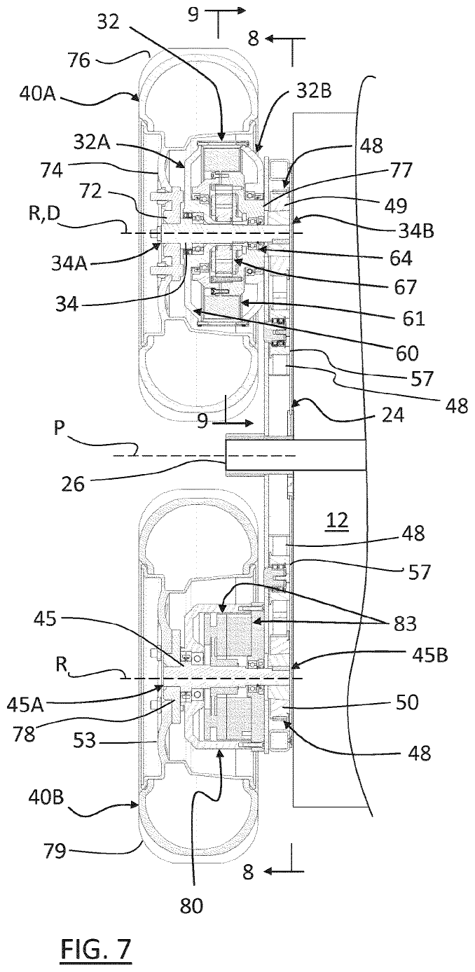

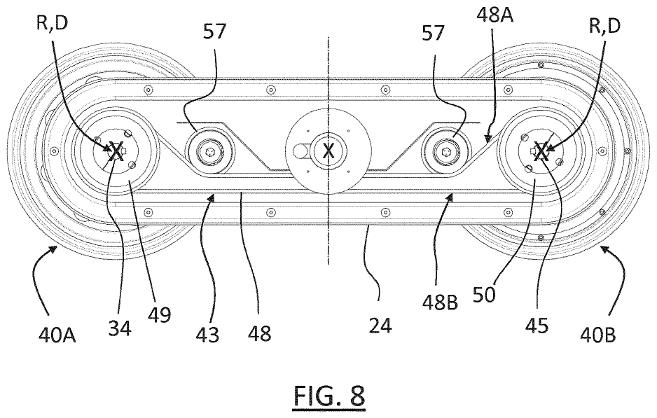

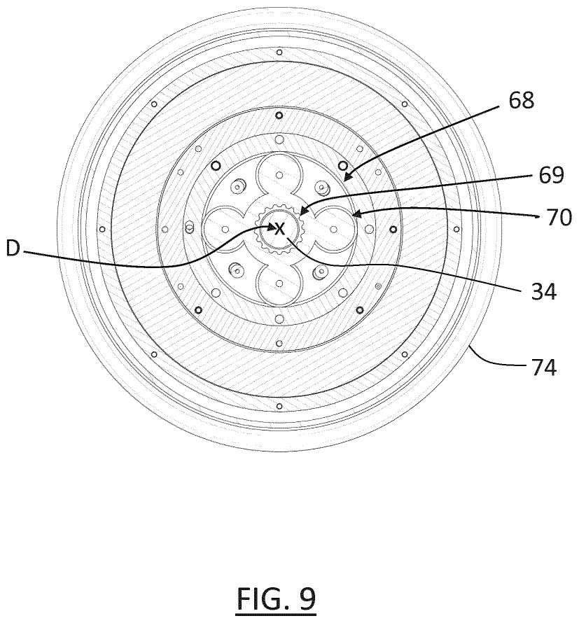

To drive the wheels, the vehicle 10 includes a plurality of electric drive motors 32 operatively connected to the electric power source 29, for example by appropriate circuitry, so as to be configured to receive the electrical power therefrom. The electric drive motors 32 are supported at the sides 15 of the frame 12 and respectively associated with the tandem pairs 21 of the wheels 19. Each electric drive motor 32 has a drive shaft 34 configured to rotate about an axis D thereof responsive to electrical power to the electric drive motor. The motors 32 include a control system in the form of one or more controllers 37 (schematically shown) operatively communicated with the motors, for example by wired communication, to control rotations of the drive shafts 34, including directionality and speed of rotation. Typically, each motor has a corresponding one of the controllers for controlling delivery of electrical power thereto, and consequently the speed and direction of shaft rotation. In such an arrangement, the plural controllers may be in communication with a central controller 38 configured to transmit commands or instructions to the power controllers 37 so that the individual motor power controllers are cooperatively controllable to provide an overall operation of the vehicle 10, that is to displace the vehicle in a desired direction of travel. Typically, the individual motor controllers 37 and the central controller 38 are housed in a common housing carried on the vehicle frame 12, even though in FIG. 6 the motor controllers are schematically shown 37 in a different location. For example, the vehicle is displaceable in a forward direction of travel in which the front end 14A of the frame is leading and in a rearward direction of travel in which the rear frame end 14B is leading.

More specifically, regarding powertrain of the vehicle, a first wheel of each tandem pair, indicated at 40A, is rotationally supported on the drive shaft 34 of an associated one of the electric drive motors 32 to form a master drive wheel of the tandem pair. Thus, the respective rotational axis R of the master drive wheel 40A is defined by the drive shaft 34 of the associated electric motor, such that the drive shaft axis D and the rotational axis R of the master drive wheel 40A are coincident or registered with each other.

Furthermore, a second wheel of each tandem pair, indicated at 40B, is operatively connected to the associated electric drive motor 32 by a transmission 43 to form a slave drive wheel driven in rotation about the respective rotational axis R thereof. Typically, as in the illustrated arrangement, the slave drive wheel 40B includes a shaft 45 defining the rotational axis R thereof and rotatably supported at a corresponding side 15 of the frame on which the tandem pair is located.

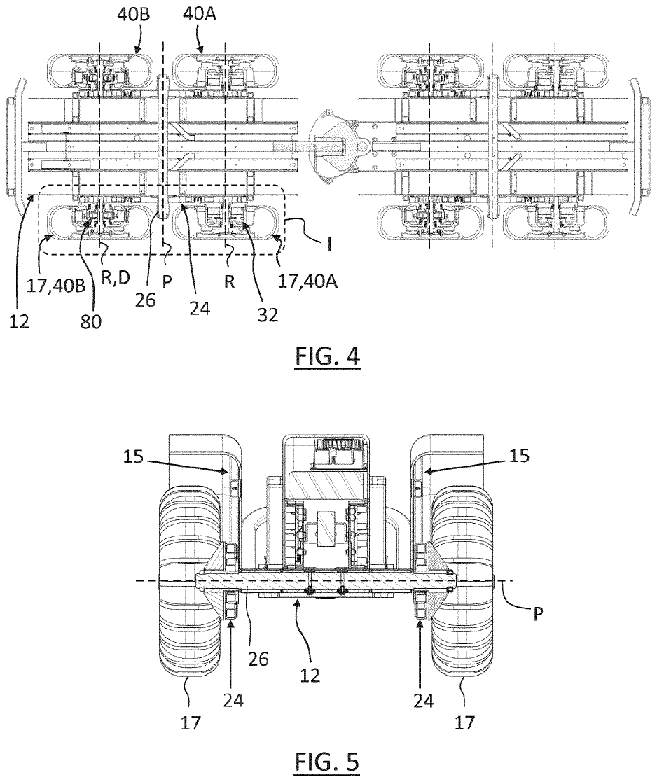

In the illustrated arrangement, and as more clearly shown in FIG. 4, within each laterally opposite pair 21 of tandem wheel pairs 19, the master drive wheels of the laterally opposite pair are in laterally opposite relation to one another, and more specifically, on each side 15 of the vehicle, the master drive wheel is a rear one of the wheels of the respective tandem pair and the slave drive wheel is a front one of the wheels of the respective tandem pair. It will be appreciated that ‘front’ and ‘rear’ are with respect to the wheels are referenced relative to the front and rear ends 14A, 14B of the frame.

To transmit rotation from the master drive wheel 40A to the slave drive wheel 40B within a common tandem pair, the transmission 43 is in the form of a rotary loop member 48 operatively supported on the drive shaft 34 of the electric drive motor and the shaft 45 of the slave drive wheel. More specifically, the rotary loop member 48 is operatively supported on these shafts by being entrained on support wheels 49, 50 respectively mounted in fixed rotational relation to the drive shaft 34 of the electric drive motor and the shaft 45 of the slave drive wheel. Thus, the shaft 45 of the slave drive wheel rotates at the same speed as the drive shaft 34 of the electric drive motor. In the illustrated arrangement, the master drive wheel 40A is supported on the drive shaft 34 on an outer side 32A of the motor, distal to the frame 12, similarly to the slave drive wheel 40B in which a hub 53 thereof is supported at or adjacent an outer end 45A of the shaft 45 distal to the frame 12. (More specifically, in the illustrated arrangement, the slave drive wheel hub is at the outer shaft end 45A.) As such, the support wheel mounted to the motor drive shaft 34, in this case that indicated at 49, is supported thereon in opposite axial relation to the master drive wheel 40A, such that the motor drive shaft 34 protrudes from an inner side 32B of the electric drive motor proximal to the frame 12.

Additionally, and correspondingly, the slave drive wheel shaft 45 extends from the outer end 45A to an inner end 45B proximal to the frame 12, and a respective one of the support wheels supported on the shaft 45 of the slave drive wheel, in this case that indicated at 50, is disposed at or adjacent the inner end 45B of the shaft of the slave drive wheel. In the illustrated arrangement, the loop support wheel 50 is disposed at the end 45B of the shaft.

Thus, the support wheels 49, 50 on the constituent rotational shafts of the tandem pair are provided in a common upstanding rotational plane and presented on inner sides of the wheels of a common tandem pair 19, so as to be located intermediate the wheels and the frame of the vehicle. To further protect the transmission, the support member 24 is in the form of a substantially enclosing housing so as to resist admittance of debris into an interior thereof, and the transmission 43, including the rotary member 48 and the support wheels 49, 50, is disposed inside the housing 24. In the illustrated arrangement, the housing 24 is fully enclosed and is substantially sealed at openings through which other elements, such as shafts, pass therein.

In the illustrated arrangement, in each tandem wheel pair 19, the pivot axis P is colinear with the rotational axes R of the constituent wheels, and accordingly, upper and lower runs 48A, 48B of the loop member 48 are guided to a common side of the pivot axis P, which in this case is a lower or underside. Guide rollers 57 are arranged in rolling engagement with the upper run of the loop member at locations intermediate the pivot shaft 26 and the support wheels 49, 50 and in longitudinally spaced relation thereto to shape the loop member 48, especially the upper run 48A, into a path clear of the pivot shaft 26. The transmission 43 is substantially symmetrical about on either side longitudinally of the pivot axis P. Furthermore, in the illustrated arrangement, the pivot axis P is centrally intermediate the rotational axes R of the wheels of the tandem pair so as to be equidistant to each of the rotational axes. In other arrangements, the upper and lower runs 48A, 48B of the loop member are on opposite sides of the pivot axis P such that the loop member 48 encompasses the pivot axis of the tandem pair.

To minimize maintenance of the transmission, especially as it is enclosed in the housing-like pivotal support member 24, the rotary loop member 48 is a belt, and the support wheels 49, 50 are pulleys. In another arrangement, the rotary loop member is a chain and the support wheels are in the form of sprockets.

Turning back to the drive motors 32, it will be appreciated that both ends 34A, 34B of the drive shaft 34 of each drive motor are disposed externally of a body of the motor 32 which is substantially formed by a rotor 60 and a stator 61 thereof. In particular, a first end portion of the drive shaft defining a first one of the ends, in this case that indicated at 34B, which is arranged in proximal relation to the frame as compared to the opposite end 34A which is distal to the frame, passes through the stator 57 to present the end 34A thereof externally of the motor body. The stator 61 thus comprises an opening which locates a bearing 64 for rotationally supporting the drive shaft 34. It will be appreciated that the motor body is substantially formed by the rotor and stator in that a majority of a space or volume occupied by the motor is formed thereby; even though the drive shaft protrudes therefrom, one or more exposed end portions of the drive shaft are volumetrically negligible in comparison a collective volume of the rotor and stator.

The electric drive motor 32 of each tandem pair 19 further includes an internal transmission 67 operatively connecting the rotor 60 and the drive shaft 34 and configured to provide a reduced rotational speed of the drive shaft 34 relative to the rotor 60. For example, the internal transmission is configured to provide a 3:1 reduction in speed between the rotor and the drive shaft. Reducing rotational speed of the drive shaft in turn acts to increase rotational torque applied thereto and accordingly the vehicle torque (as commonly understood in relation to self-propelled vehicles). In the illustrated arrangement, the internal motor transmission 67 is in the form of a planetary gearset having an outer ring gear 68 of the assembly which is supported in static condition (typically by being fixedly mounted to a bracket for mounting the motor to a supporting member or body), an inner sun gear 69 of the gearset mounted in fixed rotational relation to the rotor 60 and plural intermediary planet gears 70 at angularly spaced positions of the drive shaft disposed in radially intermediate relation to the drive shaft and rotor, relative to the drive shaft axis D. Furthermore, a planetary gear carrier (not shown) is mounted in fixed rotational relation to the drive shaft 34. In other arrangements, the internal motor transmission may be a harmonic drive or cycloidal drive.

In the illustrated arrangement, the electric drive motors 32 are of an outrunner type, as may be referred to in industry, in which the rotor 60 is supported for rotation around the stator 61 outwardly thereof relative to a radial direction of the electric drive motor, that is radially of the drive shaft axis D. In such an arrangement, the internal transmission 67 is disposed axially intermediate the rotor and the stator, that is, between the rotor and the stator relative to the axial direction of the motor along the drive shaft axis D. As such, the internal transmission 67 is contained within the body of the motor. In other arrangements, the electric drive motors may be of an inrunner type, as referred to in industry, in which the rotor is supported for rotation around the stator inwardly thereof relative to the radial direction of the electric motor.

In order to transmit rotation of the drive shaft 34 to the master drive wheel 40A, there is provided a hub-mounting flange 72 at an outer one of the ends 34A of the drive shaft which interconnects, in fixed rotational relation, a hub or rim 74 of the master drive wheel to the drive shaft 34. The rim 74 extends radially outwardly and axially relative to the drive shaft so as to substantially envelop the body of the motor. The motor body is substantially enveloped by the rim in that besides the inner side of the motor 32B which is basically in butting engagement with the support member 24, the rim 74 covers remaining portions thereof which are free of mounting or fastening to another element. The master drive wheel 40A includes a tire 76 mounted on the rim 74, as is conventional of a ground-engaging wheel.

Opposite to the hub-mounting flange 72, the motor 32 includes a motor-mounting flange 77 attached to the stator 61 externally of the motor and disposed on the inner side 32B thereof. The motor-mounting flange 77 interconnects the body of the motor and the support member 24. The flange 77 is annular and receives the drive shaft 34 passing therethrough.

The hub 53 of the slave drive wheel is mounted by an annular flange 78 to the shaft 45 in fixed rotational relation thereto, and the slave drive wheel further includes a tire 79.

Typically, electric motors effectively act as brakes when no electrical power is applied to rotate their rotors. However, to resist any external forces from mechanically effecting rotation of the rotos, the land vehicle 10 includes a plurality of brakes 80 respectively operatively connected to the slave drive wheels 40B of the tandem wheel pairs 19 so as to be configured for braking the slave drive wheels. This acts to complement, within each tandem pair, (electrical) braking by the electric motor on the master drive wheel, and provides a master braking wheel in each tandem pair. Since the wheels of a common tandem pair are operatively interconnected by a transmission for simultaneous rotation, in this case by the rotary loop member 48, this transmission acts to transmit braking action to the master drive wheel, which thus becomes a slave braking wheel in each tandem pair during operation of the brakes associated with the slave drive wheels. In the illustrated arrangement, the brakes 80 are electromagnetic brakes operatively connected to the electric power source 29, for example by appropriate electrical circuitry, so as to be configured to receive electrical power therefrom. The electromagnetic brakes are configured to be biased to a braking or stopping position when there is no electrical power applied thereto, so as to resist rotation of the wheel to which the respective brake is operatively connected. That is, in the braking position, plural elements of a braking assembly 83 are disposed in engagement in such a manner as to resist rotation of the rotational shaft 45 of the braking wheel 40B. For example, the braking assembly 83 is in the form of an assembly of frictionally-engaging axially-displaceable elements such as discs, one of which is supported in fixed rotational relation to the shaft 45 and the other which is rotationally stationary, and which are movable relative to one another axially of the shaft 45 between the braking position in which the elements are in contact with each other and an inactive position in which the elements are retracted from each other, so as to be disposed in spaced relation thereto, specifically in axially therefrom, so as to be free of engagement with one another. Typically, the stationary element is supported in fixed rotational relation and is axially movable relative to the shaft while the rotatable element, supported in fixed rotational relation to the shaft, is located at a fixed axial location of the shaft. The brakes 80 are particularly suited for use as parking brakes to prevent rolling of the landing vehicle conduced by gravity when the vehicle is stopped. The construction of the electromagnetic brakes of the illustrated arrangement is conventional and thus not described in further detail herein. Each brake 80 is substantially enveloped by the hub or rim 53 of the master brake or slave drive wheel, similarly to how the drive motor 32 is substantially enveloped by the master drive wheel's rim 74.

In use, the land vehicle 10 is propelled by applying electrical power to hub-mounted electric drive motors 32 associated with select ones of the wheels 17 arranged in plural pivotal tandem pairs, and more specifically, to only one wheel of each tandem wheel pair. The hub-mounted drive motors 32 are associated with select wheels in that the drive shafts of the motors support rotation of the wheels and receive the wheels mounted thereto. Although the other wheel of each tandem pair is not supported on the drive shaft of the motor, rotation of the motor is transmitted thereto by a transmission comprising a rotary loop member operatively interconnecting the drive shaft of the motor with a rotational shaft of the other wheel. Since the other wheel, which forms a slave drive wheel, is free of direct axial coupling to a motor, it is available to receive a brake of the tandem wheel pair to cooperate with (electrically-originating) braking action inherent to an electric motor in the absence of electrical power thereto. Thus the tandem wheel pair is braked by applying a brake on the slave drive wheel which is free of direct axial coupling to any electric motor. That is, the shaft of the slave wheel does not pass through an electric motor and is thus available for operative connection and association with a brake, preferably of the electromagnetic type.

This provides an all-wheel-drive configuration of the land vehicle utilizing “hub-mounted” electric motors, as they are typically referred to in industry, but in a number fewer than the number of wheels, which may improve electrical efficiency of the vehicle, reduce cost of production of such a vehicle and reduce weight or mass of such a vehicle which in turn may improve battery travel range.

As described hereinbefore, the present invention relates to a land vehicle which comprises a frame supported for movement across a support surface having longitudinally opposite front and rear ends and laterally opposite sides. The vehicle includes plural pivotal tandem wheel pairs respectively formed by a distinct pair of longitudinally adjacent wheels supported for pivotal movement about a common pivot axis for the wheels of the tandem pair. The vehicle further includes electric drive motors supported at the sides of the frame and respectively associated with the tandem pairs. Each motor supports one of the wheels of each tandem pair, such that a rotational axis of the master drive wheel is the same as an axis of a drive shaft of the motor. The other wheel of each tandem pair is operatively connected to the motor associated with that tandem pair by a transmission to form a slave drive wheel driven in rotation about its own rotational axis.

The scope of the claims should not be limited by the preferred embodiments set forth in the examples but should be given the broadest interpretation consistent with the specification as a whole.

1. A land vehicle comprising:
a frame arranged for movement across a support surface, wherein the frame has longitudinally opposite front and rear ends and laterally opposite sides;
a plurality of wheels supported at the sides of the frame for supporting the frame in movement across the support surface, wherein the wheels on common sides of the frame are arranged in tandem pairs including respective ones of the wheels which are adjacent each other relative to a longitudinal direction of the frame;
wherein each of the tandem pairs of the wheels is supported for pivotal movement relative to the frame about a substantially laterally oriented pivot axis, wherein the pivot axis is disposed longitudinally intermediate respective rotational axes of the wheels of the tandem pair;
wherein the respective rotational axis of each wheel of each tandem pair is distinct from the pivot axis associated with the tandem pair to which the wheel belongs;
an electric power source carried on the frame and configured to supply electrical power;
a plurality of electric drive motors operatively connected to the electric power source so as to be configured to receive the electrical power therefrom, wherein the electric drive motors are supported at the sides of the frame and respectively associated with the tandem pairs of the wheels,
wherein each of the electric drive motors has a drive shaft configured to rotate about an axis thereof responsive to electrical power to the electric drive motor;
wherein a first one of the wheels of each tandem pair is rotationally supported on the drive shaft of an associated one of the electric drive motors to form a master drive wheel of the tandem pair, wherein the respective rotational axis of the master drive wheel is defined by the drive shaft of the associated electric motor; and
wherein a second one of the wheels of each tandem pair is operatively connected to the associated electric drive motor by a transmission to form a slave drive wheel driven in rotation about the respective rotational axis thereof.

2. The land vehicle of claim 1 further including a plurality of brakes respectively operatively connected to the slave drive wheels of the tandem pairs so as to be configured for braking the slave drive wheels.

3. The land vehicle of claim 2 wherein the brakes are electromagnetic brakes operatively connected to the electric power source so as to be configured to receive electrical power therefrom.

4. The land vehicle of any one of claims 1 to 3 wherein, when the slave drive wheel of each tandem pair includes a shaft rotatably supported at a corresponding one of the sides of the frame, the transmission operatively interconnecting the slave drive wheel with the associated electric drive motor is in the form of a rotary loop member operatively supported on the drive shaft of the electric drive motor and the shaft of the slave drive wheel.

5. The land vehicle of claim 4 wherein the rotary loop member is entrained on support wheels respectively mounted in fixed rotational relation to the drive shaft of the electric drive motor and the shaft of the slave drive wheel.

6. The land vehicle of claim 5 wherein, when the master drive wheel is supported on the drive shaft of the electric drive motor on an outer side thereof distal to the frame, a respective one of the support wheels mounted to the drive shaft is supported thereon in opposite axial relation to the master drive wheel such that the drive shaft protrudes from an inner side of the electric drive motor proximal to the frame.

7. The land vehicle of claim 6 wherein, when a hub of the slave drive wheel is supported at or adjacent an outer end of the shaft of the slave drive wheel distal to the frame and when the shaft extends from the outer end to an inner end proximal to the frame, a respective one of the support wheels supported on the shaft of the slave drive wheel is disposed at or adjacent the inner end of the shaft of the slave drive wheel.

8. The land vehicle of claim 7 wherein the wheels of each tandem pair are supported on a support member in the form of a housing which is substantially enclosed and the rotary loop member is inside the housing.

9. The land vehicle of any one of claims 5 to 8 wherein the rotary loop member is a belt and the support wheels are pulleys.

10. The land vehicle of any one of claims 4 to 9 wherein, for each tandem pair of the wheels, the pivot axis is colinear with the rotational axes of the wheels of the tandem pair and upper and lower runs of the rotary loop member are guided to a common side of the pivot axis.

11. The land vehicle of any one of claims 1 to 10 wherein, when the electric drive motor of each tandem pair has a stator and a rotor, the electric drive motor further includes an internal transmission operatively connecting the rotor and the drive shaft and configured to provide a reduced rotational speed of the drive shaft relative to the rotor.

12. The land vehicle of claim 11 wherein the internal transmission is in the form of a planetary gearset.

13. The land vehicle of claim 11 or 12 wherein, when the rotor is supported for rotation around the stator outwardly thereof relative to a radial direction of the electric drive motor, the internal transmission is disposed axially intermediate the rotor and the stator.

14. The land vehicle of any one of claims 1 to 13 wherein, when the tandem pairs of the wheels are provided in laterally opposite pairs which are registered with each other at a common longitudinal position of the frame, the master drive wheels of the tandem pairs of a common one of the laterally opposite pairs are rear ones of the wheels of the tandem pairs.
